(19) United States
(12) Patent Application Publication
(10) Pub. No.: US 2008/0063399 A1
(43) Pub. Date: Mar. 13, 2008

(54) METHODS AND APPARATUS TO IMPLEMENT COMMUNICATION NETWORKS USING ELECTRICALLY CONDUCTIVE AND OPTICAL COMMUNICATION MEDIA

(76) Inventors: Arvind R. Mallya, Walnut Creek, CA (US); Kapil Shrikhande, Berkeley, CA (US)

Correspondence Address: HANLEY, FLIGHT & ZIMMERMAN, LLC, 150 S. WACKER DRIVE, SUITE 2100, CHICAGO, IL, 60606, US

(21) Appl. No.: 11/531,326

(22) Filed: Sep. 13, 2006

(51) Int. Cl. H04J 14/00

(52) U.S. Cl. 398/75

(57) ABSTRACT

Example methods and apparatus to implement communication networks using electrically conductive and optical communication media are disclosed. An example method involves receiving first communication information via a conductive communication medium and second communication information via a first optical fiber communication medium. The first communication information and the second communication information are multiplexed to form a multiplexed communication signal. The multiplexed communication signal is communicated via a second optical fiber communication medium to a subscriber distribution device.

### FIELD OF THE DISCLOSURE

The present disclosure relates generally to communications systems and, more particularly, to methods and apparatus to implement communication networks using electrically conductive and optical communication media.

### BACKGROUND

Telecommunication companies often upgrade existing communication networks implemented using copper cables by replacing the previously installed copper cables with optical fiber to provide relatively higher bandwidth to customers. In addition, in newly developed areas (e.g., new residential areas or new business areas) telecommunication companies sometimes expand existing networks using optical fiber only to the newly developed areas. For example, in fiber-to-the-home (“FTTH”) network implementations a communication circuit (e.g., a communication path) between a telephone company central office and a customer site (e.g., a customer household, a customer office building, etc.) is formed using optical fiber segments without any electrical conductor (e.g., copper cable) segments. Thus, a FTTH customer receives communication services via high-speed optical fiber only.

Unlike traditional electrically conductive cables (e.g., copper cables), optical fiber provides relatively higher bandwidth that enables many more types of data/voice communication services and the ability to serve more customers using fewer communication media. For example, one optical fiber can carry data/voice information corresponding to the same number of customers that would ordinarily require a plurality of electrical conductors. A drawback to replacing electrical conductors with optical fiber or installing only optical fibers in new areas is lack of a medium to carry electrical power. That is, in network portions that use electrical conductors, the electrical conductors can carry electrical power to power telecommunications equipment (e.g., switches) located in remote areas.

Without electrical conductors in a communication circuit, power must be supplied to telecommunication devices (e.g., switches, cross-connectors, multiplexers, demultiplexers, customer premises equipment, etc.) from alternate sources. An example source of electrical power includes a power company's power grid. However, drawing electrical power from a power company's power grid creates additional expenses and increases network installation times to connect the power grid to the remotely located telecommunication equipment. Additionally, if the power grid fails, which often happens during inclement weather, customers may be left without voice and/or data communication services. Such outages are not acceptable according to Federal Communication Commission regulations that prohibit landline voice communications from failing for more than a specified amount of time per year, which is far less than the duration for which power grids fail per year.

### BRIEF DESCRIPTION OF THE DRAWINGS

FIG. 1 depicts an example network system that may be implemented using the example methods and apparatus described herein.

FIG. 2 depicts a general block diagram of an example serving area interface.

FIG. 3 depicts a detailed block diagram of the example serving area interface of FIG. 2.

FIG. 4 depicts a general block diagram of an example add-drop multiplexer.

FIG. 5 depicts a detailed block diagram of the example add-drop multiplexer of FIG. 4.

FIGS. 6A-6D illustrate a flowchart representative of an example method that may be used to implement the example serving area interface of FIGS. 2 and 3.

FIGS. 7A and 7B illustrate a flowchart representative of an example method that may be used to implement the example add-drop multiplexer of FIGS. 4 and 5.

FIG. 8 is a block diagram of an example processor system that may be used to implement the example apparatus, methods, and articles of manufacture described herein.

### DETAILED DESCRIPTION

The example methods and apparatus described herein may be used to implement communication networks using electrically conductive and optical communication media. As the bandwidth of telecommunication equipment increases, telecommunication networks deployed using only electrically conductive communication media (e.g., copper conductors) are becoming bandwidth limited. As telecommunication networks expand to new areas (e.g., new neighborhoods, new office buildings, new industrial parks, etc.) telecommunication companies install optical fiber to advantageously use the increased bandwidth capabilities enabled by the optical fiber. In this manner, telecommunication companies can provide services to more customers and relatively higher speed network services and features.

The example methods and apparatus described herein can be used to upgrade existing copper-only network portions (e.g., portions of networks implemented using electrical conductors only) with optical fibers to provide more communication services and higher speed services (e.g., broadband Internet access, broadband television, etc.) to those existing areas. In addition, the example methods and apparatus may be used to expand communication networks to new areas using optical fiber and electrically conductive communication media. In particular, the example methods and apparatus may be used to install optical fiber communication media in combination with electrically conductive media to communicate communication signals via the optical fiber media and/or the electrically conductive media and to transmit electrical power via the electrically conductive media. In this manner, in existing network areas a communication service provider need not remove all of the previously installed electrically conductive media, replace it with optical fiber, and switch all of the existing services completely to the optical fiber-based network. Instead, a communication service provider can save the added expense of removing the electrically conductive media by installing the optical fiber in combination with existing electrically conductive media and offering new services via the optical fiber while slowly converting some or all existing services from the electrically conductive media to optical fiber.

In addition, although optical fiber networks enable delivery or relatively higher speed network services and features, networks containing only optical fiber communication media lack the capability to enable delivering electrical power to service provider telecommunication equipment (e.g., switches, remote terminals, etc.) and subscriber telecommunication equipment (e.g., telephones, network interfaces devices, modems, etc.). Powering telecommunication equipment with stable, reliable electricity is essential to continuous, failsafe delivery of communication services to subscribers. A drawback to installing only optical fibers in a telecommunications network is the lack of a medium to carry electrical power. That is, in network portions that use electrical conductors, the electrical conductors can carry electrical power to power telecommunications equipment (e.g., switches, remote terminals, etc.) located in remote areas. However, without the electrical conductors, power must be supplied from alternate sources such as, for example, power company power grids, batteries, etc.

Power company power grids can be used to provide electrical power. However, tapping into power company power grids to obtain electrical power is an added expense. Additionally, if the power grid fails, which often happens during inclement weather, customers may be left without voice and/or data communication services. Such outages are not acceptable according to Federal Communication Commission regulations that prohibit landline voice communications from failing for more than a specified amount of time per year, which is far less than the duration for which power grids fail per year.

Using the example methods and apparatus described herein to implement communication networks using electrically conductive and optical communication media enables delivering electricity to remotely located telecommunications equipment via the electrically conductive communication media from a source of stable, reliable electricity (e.g., a telephone company electrical power source having a backup power source such as batteries or generators).

An example method that may be used to implement a communication network using electrically conductive and optical fiber media involves receiving first communication information (e.g., voice information) via an electrically conductive communication medium (e.g., a copper communication medium) and second communication information (e.g., data information) via a first optical fiber communication medium. For example, the first and second communication information may be received at a telecommunication terminal (e.g., a serving area interface (“SAI”) terminal) communicatively coupled to the electrically conductive communication medium and the first optical fiber communication medium. The first communication information and the second communication information are then multiplexed (at, for example, the telecommunication terminal) to form a multiplexed communication signal. The multiplexed communication signal is then communicated (by, for example, the telecommunication terminal) via a second optical fiber communication medium to a subscriber distribution device.

In an example implementation, receiving the first communication information via the electrically conductive communication medium involves receiving the first communication information using a plain old telephone system (“POTS”) protocol and converting the first communication information from the POTS protocol to a time division multiplex (“TDM”) protocol. The first communication information converted to the TDM protocol may then be encoded using a synchronous optical network (“SONET”) protocol. In an alternative example implementation, the first communication information (e.g., voice information) is received using a TDM protocol and the second communication information (e.g., data information) is received using a digital subscriber line (“DSL”) protocol (e.g., an asymmetric DSL (“ADSL”) or a very high bit-rate DSL (“VDSL”) protocol).

In an example implementation, prior to multiplexing the first and second communication information, the second communication information may be encoded in a sub-carrier multiplex (“SCM”) signal. In addition, regardless of whether the second communication information is encoded in a SCM signal, the multiplexed communication signal may be communicated via the second optical fiber communication medium using a dense wavelength division multiplexing (“DWDM”) protocol or a SONET protocol.

In some example implementations, the second optical fiber communication medium is provided in combination with a second electrically conductive communication medium using a hybrid cable. In this manner, the multiplexed communication information can be communicated via the second optical fiber communication medium while other communication information and/or electrical power is communicated or transmitted via the second electrically conductive communication medium of the hybrid cable. The second conductive communication medium can also be used to communicate alarm information (e.g., network outage information, network maintenance information, network monitoring information, etc.) and/or to provide emergency analog communication channels (e.g., 911 service) to subscribers.

An example apparatus (e.g., a telecommunication terminal) that may be used to implement a communication network using electrically conductive and optical fiber media includes an electrical interface to receive an electrical SONET signal and an electrical SCM signal carrying a DSL signal (e.g., an ADSL or a VDSL signal). To convert the electrical SONET signal to an optical TDM signal, the example apparatus includes a first multiplexer/demultiplexer (“mux/demux”) communicatively coupled to the electrical interface. To convert the electrical SCM signal to an optical SCM signal, the example apparatus is provided with a second mux/demux communicatively coupled to the electrical interface. To communicate the optical TDM signal via a first optical fiber and the optical SCM signal via a second optical fiber, the example apparatus is provided with an optical interface communicatively coupled to the first mux/demux and the second mux/demux.

In an example implementation, to convert the electrical SONET signal and the electrical SCM signal to a DWDM signal the example apparatus also includes a third mux/demux communicatively coupled to the electrical interface and the optical interface. The optical interface may be configured to communicate the DWDM signal via the first, the second, and/or a third optical fiber.

In some example implementations, the optical interface is configured to communicate the optical TDM signal via a first hybrid cable having the first optical fiber and a first electrical conductor. In addition, the optical interface may be configured to communicate the optical SCM signal via a second hybrid cable having the second optical fiber and a second electrical conductor.

In some example implementations, to transmit electrical power not having a communication signal, the example apparatus is provided with an electrical power interface. The electrical power interface may be configured to transmit the electrical power via a hybrid cable having the electrical conductor and one or both of the first optical fiber and the second optical fiber.

Another example method that may be used to implement a communication network using electrically conductive and optical fiber media involves receiving a multiplexed communication signal having first communication information (e.g., voice information) and second communication information (e.g., data information) via a first optical fiber communication medium. For example, the multiplexed communication signal may be received via an add-drop multiplexer communicatively coupled to first optical fiber communication medium. The multiplexed signal is transmitted via a second optical fiber communication medium. In addition, the first and second communication information are then demultiplexed from the first multiplexed communication signal and communicated to a subscriber terminal (e.g., customer premises equipment, a DSL terminal unit-remote (“ATU-R”), etc.) via an electrically conductive communication medium (e.g., a twisted-pair copper communication medium). For example, the first communication information may be communicated to the subscriber terminal using a POTS protocol and/or a TDM protocol and the second communication information may be communicated to the subscriber terminal using a DSL protocol.

In some example implementations, the multiplexed communication signal includes a pulse code modulated (“PCM”) voice signal within a SONET signal to, for example, transmit data information. Additionally or alternatively, the multiplexed communication signal includes a DSL signal within an optical SCM signal. Alternatively, in some example implementations, the multiplexed communication signal may include a DWDM signal.

Another example apparatus (e.g., a telecommunication terminal) that may be used to implement a communication network using electrically conductive and optical fiber media includes a first converter to receive an optical SONET signal and convert the optical SONET signal to a first electrical signal (e.g., an electrical SONET signal). To receive an optical SCM protocol signal and convert the optical SCM protocol signal to a second electrical signal (e.g., an electrical SCM signal), the example apparatus is provided with a second converter. In addition, to combine the first electrical signal and the second electrical signal to a third electrical signal and communicate the third electrical signal to a customer premises terminal, the example apparatus is provided with a combiner/splitter.

In an example implementation, the example apparatus includes a mux/demux communicatively coupled to the first converter and configured to demultiplex pulse code modulated (“PCM”) voice information from the first electrical signal. Additionally or alternatively, the example apparatus may include a mux/demux communicatively coupled to the second converter and configured to extract data information from the second electrical signal.

To transmit the optical SONET signal and/or the optical SCM protocol signal to a subscriber distribution device, the example apparatus may be provided with an optical interface. For example, the example apparatus may be a first subscriber distribution device that receives the SONET signal and the SCM protocol signal from a serving area interface (“SAI”) to provide communication services to a plurality of subscribers. The first subscriber distribution device may extract information from the SONET and/or SCM signals corresponding to its respective subscribers and forward the SONET and/or SCM signals to a second subscriber distribution device that provides communication services to another plurality of subscribers.

In some example implementations, to receive power via a cable (e.g., a hybrid cable) having an electrical conductor and an optical fiber, the example apparatus is provided with an electrical power interface. The first converter and the second converter may be configured to be powered by the electrical power interface.

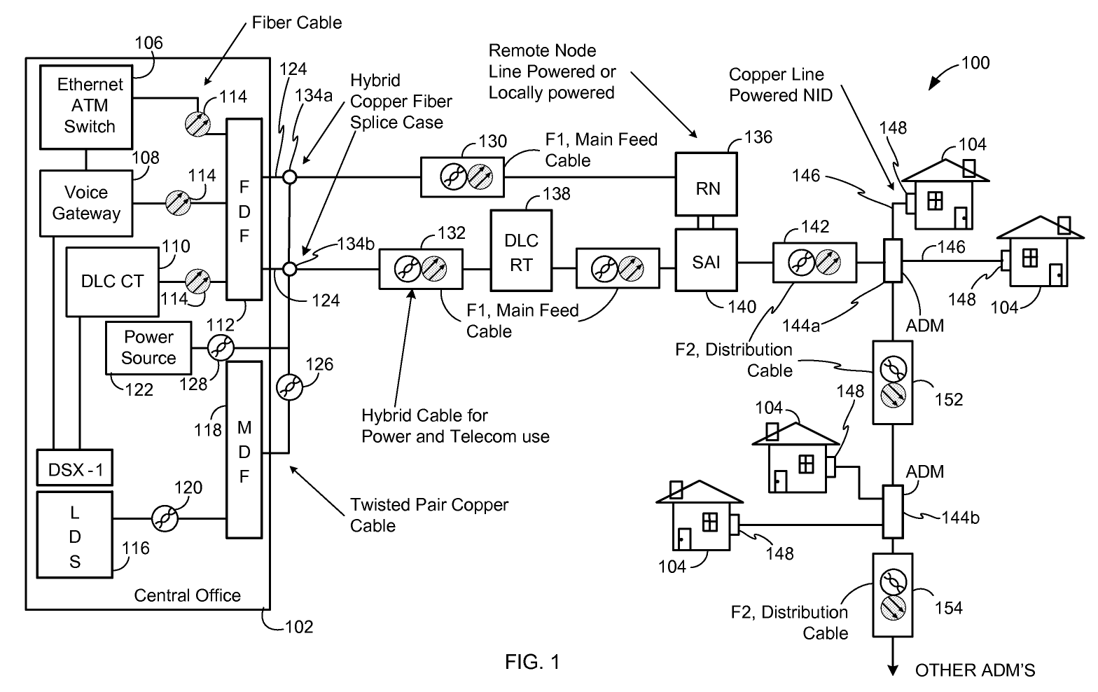

Turning to FIG. 1, an example network system 100 includes a central office (“CO”) 102 that exchanges voice and data information with customer sites 104 (e.g., subscriber sites 104). The central office 102 enables the customer sites 104 to transmit and/or receive voice and/or data information with each other and/or other entities. For example, the central office 102 may enable landline analog and/or digital telephone services, Internet services, data networking services, video services, television services, radio services, etc. Example hybrid cables including electrically conductive and optical fiber communication media may be used to communicatively couple components within the central office 102 with communications equipment at the customer sites 104 (i.e., customer premises equipment (“CPE”)). In this manner, information may be exchanged between the central office 102 and the customer sites 104 using electrical signals and/or optical signals. Electrically conductive communication media can also be used to provide electrical power, alarm information, or emergency analog communication channels. Example hybrid cables that may be used to implement the example network system 100 and/or portions thereof are described in related U.S. application Ser. No. 11/446,544 filed on Jun. 2, 2006, the specification of which is incorporated herein by reference in its entirety.

In the illustrated example of FIG. 1, the central office 102 includes an Ethernet asynchronous transfer mode (“ATM”) switch 106, a voice gateway 108, and a digital loop carrier at a central office terminal (“DLC CT”) 110. The Ethernet ATM switch 106, the voice gateway 108, and the DLC CT 110 are communicatively coupled to a fiber distribution frame (“FDF”) 112 via optical fibers 114.

The central office 102 is also provided with a local digital switch (“LDS”) 116. The LDS 116 is communicatively coupled to a main distribution frame (“MDF”) 118 via a copper cable 120. In addition, to provide electrical power to remotely located communications equipment and/or to communications equipment (e.g., network access devices, telephones, modems, etc.) located at the customer sites 104, the central office 102 is provided with a power source 122. The power source 122 may include an interface to a power company's power grid, a battery system, and/or a power generator.

Optical fibers 124 communicatively coupled to the FDF 112, a twisted pair copper cable 126 communicatively coupled to the MDF 118, and a twisted pair copper cable 128 electrically coupled to the power source 122 are spliced with example hybrid cables 130 and 132 (e.g., hybrid cables having twisted-pair electrical conductors and optical fibers) at copper-fiber splice cases 134a and 134b. The hybrid cables 130 and 132 are main feed cables (i.e., F1 cables) used to deliver electrical power and carry voice and data information from the central office 102 to remote telecommunication equipment. For example, the main feed cables 130 and 132 may be used to communicatively and/or electrically couple the central office 102 to one or more remote nodes 136 (e.g., remote node digital subscriber line access multiplexers (“RN DSLAM's”)), DLC remote terminals (“RT's”) 138, serving area interfaces (“SAI's”) 140, and/or any other telecommunication equipment. In the illustrated example, the DLC RT 138 is shown communicatively coupled between the central office 102 and the SAI 140. However, in other example implementations, the SAI 140 may be communicatively coupled directly to the central office 102 without any intervening DLC RT (e.g., without the DLC RT 138).

An example hybrid cable 142 is used to communicatively and/or electrically couple the SAI 140 to an add-drop multiplexer (“ADM”) 144a. In the illustrated example, the example hybrid cable 142 is a distribution cable (i.e., an F2 cable) that the SAI 140 uses to provide communication services to a respective service area (e.g., a residential neighborhood, a multi-unit building, an industrial park, etc.). The ADM 144a is a subscriber distribution device that is communicatively coupled to the SAI 140 via the distribution cable 142 and that provides communication information to a plurality of subscribers (e.g., the customer sites 104) connected thereto. As shown, copper cables 146 are used to communicatively and/or electrically couple the ADM 144a to network interface devices (“NID's”) 148 at the customer sites 104. Additionally or alternatively, the ADM 144a may be communicatively coupled to the NID's 148 using example hybrid cables substantially similar or identical to the example hybrid cables 130, 132, and 142. In this manner, relatively higher bandwidth capabilities may be provided to the customer sites 104 while simultaneously providing electrical power from the power source 122 at the central office 102 to the NID's 148. Providing electrical power from the power source 122 enables the NID's 148 to continue providing communication services at the customer sites 104 when power company power grid failures occur at the customer sites 104.

The add-drop multiplexer 144a also functions as a relay circuit that forwards communication signals received from the SAI 140 to another add-drop multiplexer 144b so that the add-drop multiplexer 144b can provide communication services to another plurality of subscribers connected thereto. In the illustrated example, the communication signals (e.g., multiplexed communication signals) communicated by the SAI 140 to the ADM 144a contain communication information (e.g., voice and/or data information) corresponding to some or all the subscriber sites 104 shown in FIG. 1. The ADM 144a is configured to demultiplex the communication information corresponding to its respective ones of the NID's 148 connected thereto from the multiplexed communication signals transmitted by the SAI 140 and communicate the demultiplexed communication information to the respective NID's 148. In addition, the ADM 144a is configured to forward the multiplexed communication signals to the ADM 144b via hybrid cable 152 so that the ADM 144b can demultiplex the communication information corresponding to the ones of the NID's 148 connected thereto and communicate the demultiplexed communication information to respective ones of the NID's 148. In addition, the ADM 144b is configured to forward the multiplexed communication signal to another ADM (not shown) via hybrid cable 154. A plurality of ADM's substantially similar or identical to the ADM's 144a and 144b can be communicatively coupled in a similar or identical manner to provide communication services to other customer sites (not shown).

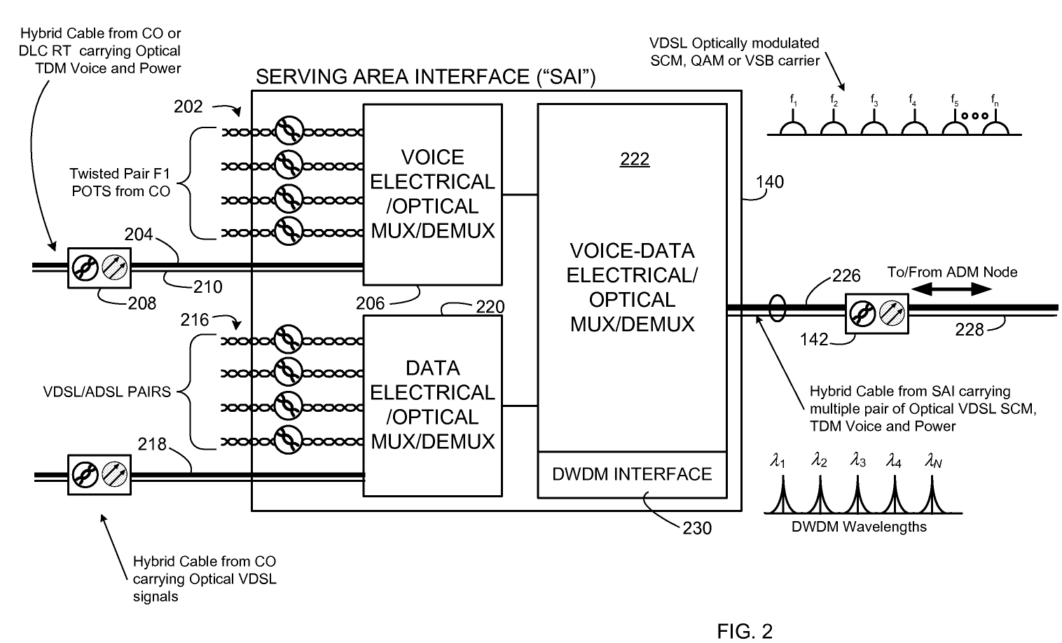

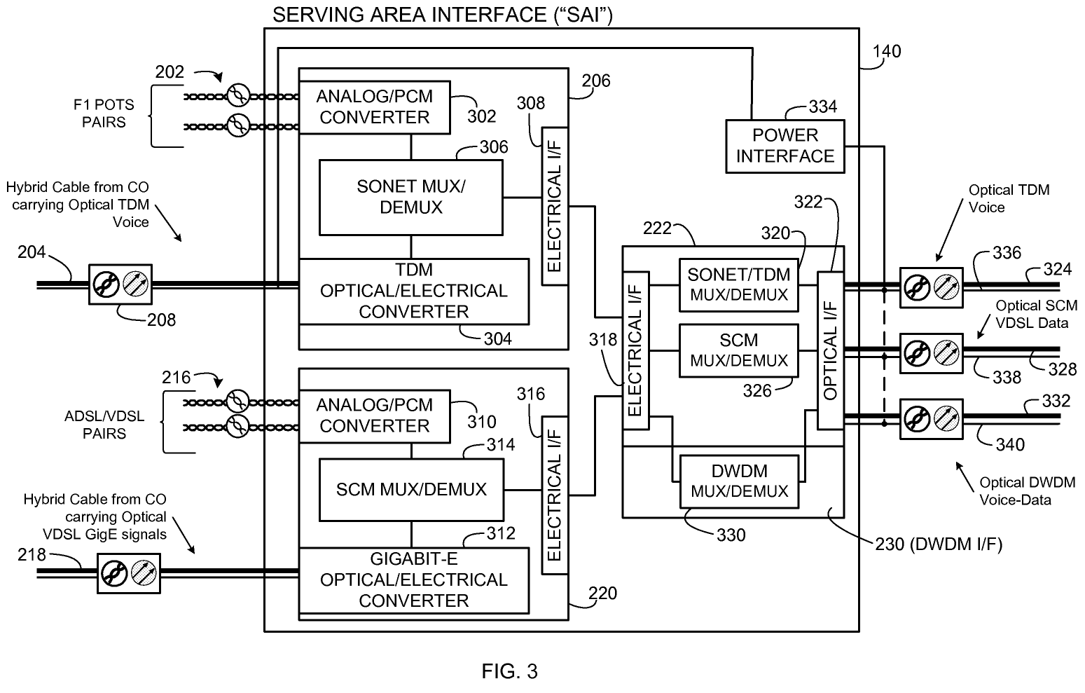

FIG. 2 is a general block diagram and FIG. 3 is a detailed block diagram of the SAI 140 of the example network system 100 of FIG. 1. The SAI 140 (e.g., remotely located communication equipment) may be installed in or near a residential neighborhood or other service area to provide communication services to subscribers (e.g., the customer sites 104 of FIG. 1) in that service area. Specifically, the SAI 140 receives communication signals (e.g., voice and/or data signals) transmitted by the central office (“CO”) 102 (FIG. 1) and/or the DLC RT 138 (FIG. 1) and forwards communication information from those communication signals to subscriber distribution devices (e.g., the ADM's 144a and 144b of FIG. 1) distributed throughout the service area served by the SAI 140. In this manner, the SAI 140 can communicate information between the central office 102 and the customer sites 104. Although the SAI 140 is described as receiving communication signals from the central office 102 and/or the DLC RT 138 of FIG. 1 and transmitting voice and/or data signals to the ADM's 144a-b, the SAI 140 is also configured to perform a reverse process including receiving voice and/or data information provided by the ADM's 144a-b (e.g., voice and/or data information originating at the customer sites 104), multiplexing the voice and/or data information into one or more communication signals, and communicating the communication signals to the central office 102 and/or the DLC RT 138.

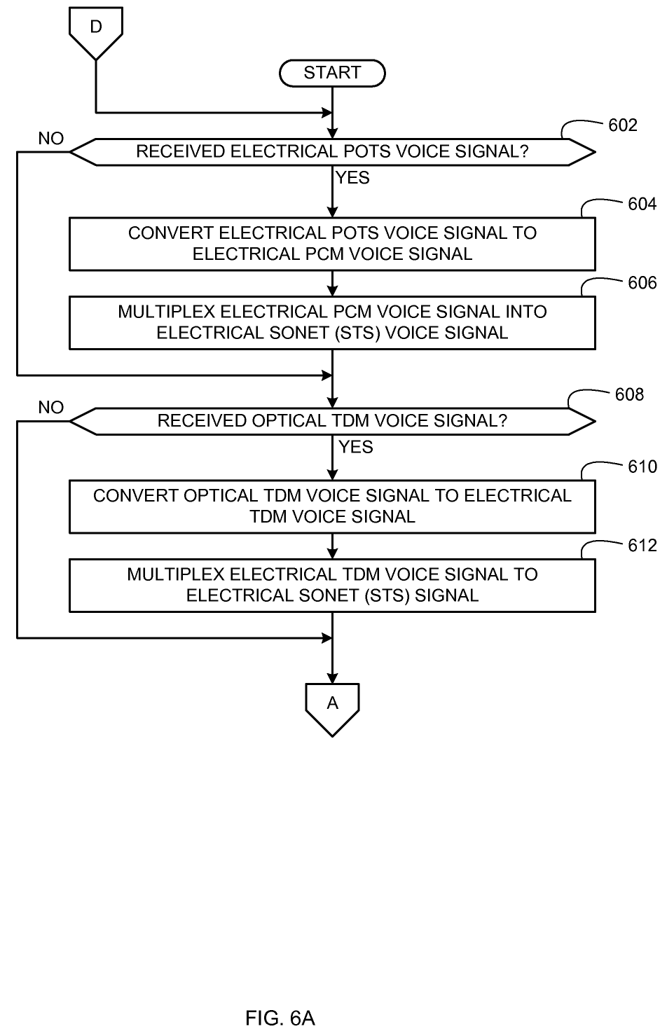

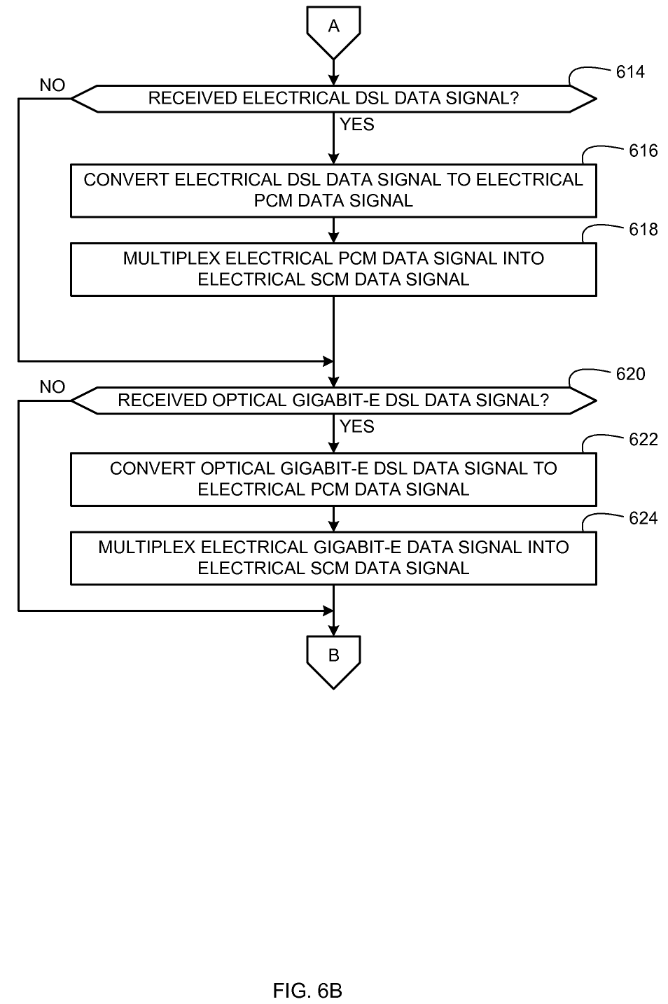

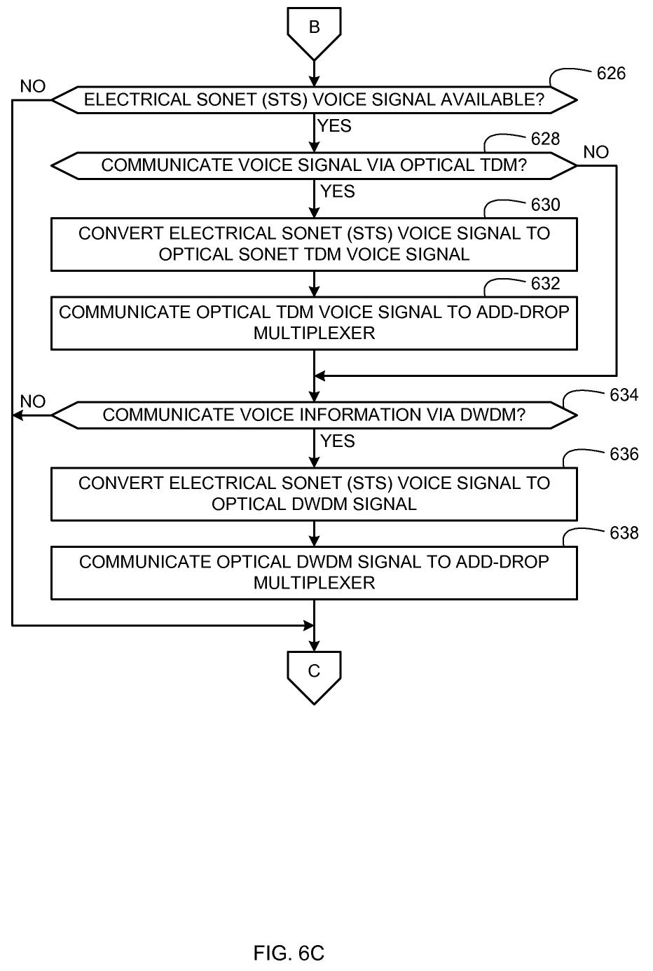

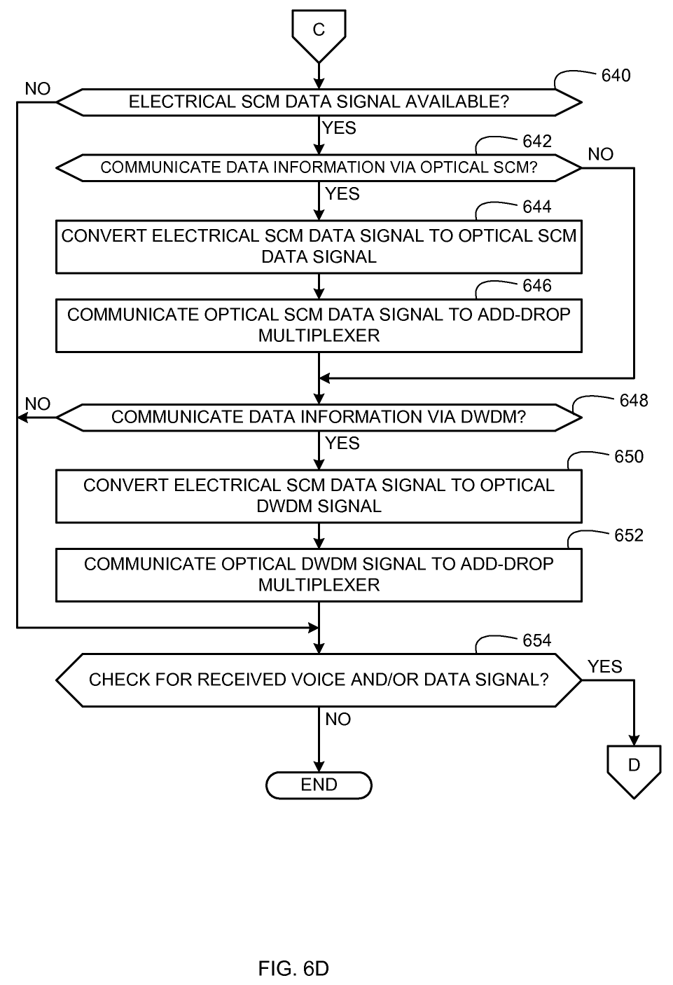

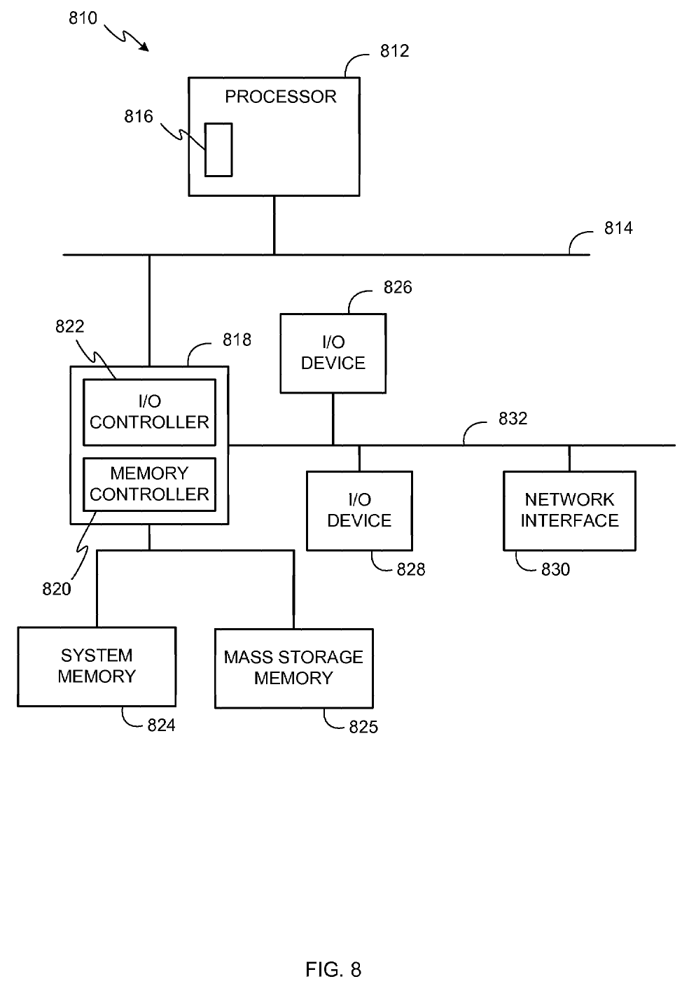

The example structures shown in FIGS. 2 and 3 may be implemented using any desired combination of hardware and/or software. For example, one or more integrated circuits, discrete semiconductor components, or passive electronic components may be used. Additionally or alternatively, some or all, or parts thereof, of the example structures of FIGS. 2 and 3 may be implemented using instructions, code, or other software and/or firmware, etc. stored on a computer-readable medium that, when executed by, for example, a processor system (e.g., the processor system 810 of FIG. 8), perform the methods described herein. Further, the example methods described below in connection with FIGS. 6A-6D describe example operations or processes that may be used to implement some or all of the functions or operations associated with the structures shown in FIGS. 2 and 3.

To receive voice information via electrically conductive communication media 202 (i.e., electrical conductors) (e.g., a plurality of twisted pair electrical conductors) and optical fiber communication media 204 (i.e., optical fibers), the SAI 140 is provided with a voice electrical/optical mux/demux 206. In the illustrated example, the voice electrical/optical mux/demux 206 is configured to receive voice signals from the central office 102 (FIG. 1) via the electrical conductors 202 (e.g., main feed (i.e., F1), twisted pair cables) using the POTS protocol. In addition, the voice electrical/optical mux/demux 206 is configured to receive voice information from the central office 102 or from the DLC RT 138 via one or more optical fibers (e.g., the optical fibers 204) of a hybrid cable 208. In the illustrated example, an electrical conductor 210 of the hybrid cable 208 is used to deliver electrical power to the SAI 140.

To receive data information via electrically conductive communication media 216 (i.e., electrical conductors) (e.g., a plurality of twisted pair electrical conductors) and optical fiber communication media 218 (i.e., optical fibers), the SAI 140 is provided with a data electrical/optical mux/demux 220. In the illustrated example, the data electrical/optical mux/demux 220 is configured to receive data information from the central office 102 (FIG. 1) via the electrical conductors 216 (e.g., main feed (i.e., F1), twisted pair cables) using the VDSL and/or ADSL protocol. In addition, the data electrical/optical mux/demux 220 is configured to receive data signals from the central office 102 via one or more optical fibers (e.g., the optical fiber communication media 218) using the VDSL protocol.

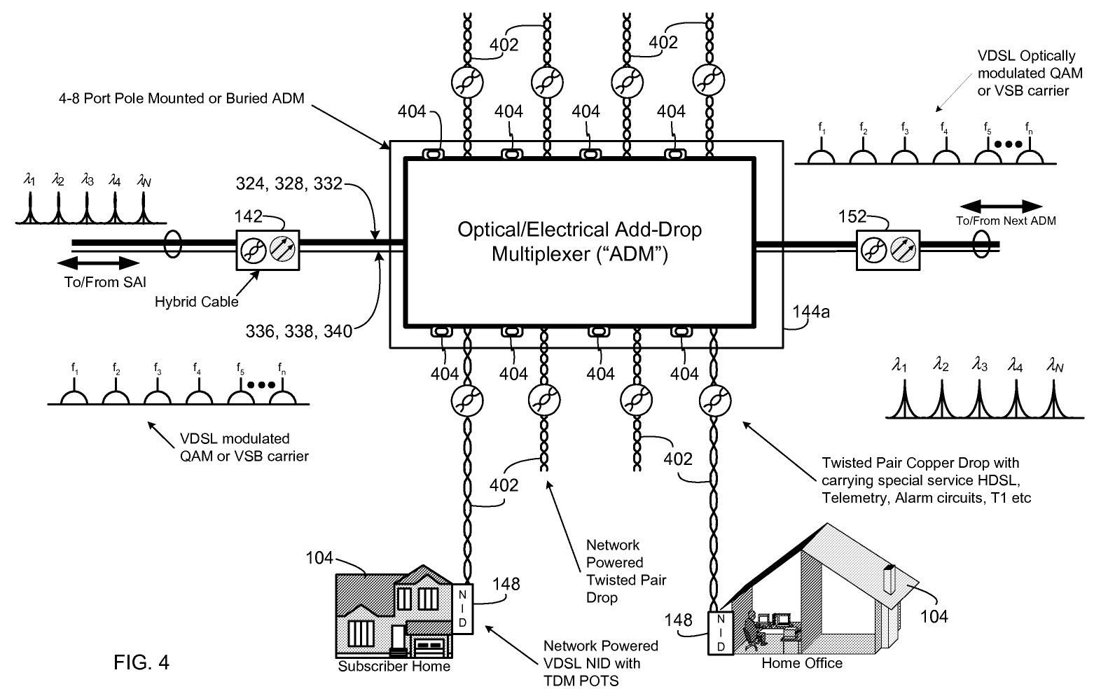

To communicate to subscribers (e.g., the customer sites 104 of FIG. 1) the voice and/or data information received by the SAI 140 from the central office 102 and/or the DLC RT 138 of FIG. 1, the SAI 140 is provided with a voice-data electrical/optical mux/demux 222. In the illustrated example, the voice electrical/optical mux/demux 206 and the data electrical/optical mux/demux 220 convert respective voice and data information into electrical signals as described in detail below in connection with FIG. 4 and communicate the electrical signals to the voice-data electrical/optical mux/demux 222. The voice-data electrical/optical mux/demux 222 then converts the electrical voice and data signals received from the muxes/demuxes 206 and 220 into optical signals and communicates the optical signals via the hybrid cable 142 to ADM's (e.g., the ADM's 144a and 144b of FIG. 1) to provide communication services to subscribers (e.g., the customer sites 104 of FIG. 1) served by the SAI 140.

In the illustrated example, the hybrid cable 142 includes a plurality of optical fibers 226 and a plurality of electrical conductors 228. In an example implementation, one or more of the plurality of optical fibers 226 are used to transmit and receive optical voice signals and one or more of the plurality of optical fibers 226 are used to transmit and receive optical data signals.

The voice-data electrical/optical mux/demux 222 may transmit optical signals using a TDM standard (e.g., SONET) for voice and a SCM standard for data. In the illustrated example, the SAI 140 is also provided with a DWDM interface 230 (e.g., a DWDM coupler fiber expansion port) to additionally or alternatively transmit combined voice and data information via optical signals using a DWDM standard. The DWDM interface 230 is configured to use two of the optical fibers 226 to transmit and receive the combined voice and data information.

Although the SAI 140 is described as transmitting voice and data information to subscribers, the SAI 140 also transmits voice and data information from subscribers to the central office 102 and/or the DLC RT 138 of FIG. 1. That is, the voice-data electrical/optical mux/demux 222 can receive optical signals having voice and/or data information generated by one or more subscribers (e.g., the customer sites 104 of FIG. 1) and convert the voice and/or data information from optical signals to electrical signals. The voice-data electrical/optical mux/demux 222 can then communicate electrical voice signals to the voice electrical/optical mux/demux 206 and electrical data signals to the data electrical/optical mux/demux 220. The voice electrical/optical mux/demux 206 and the data electrical/optical mux/demux 220 can then convert respective electrical signals to optical and/or electrical signals that they communicate to the central office 102 and/or the DLC RT 138 of FIG. 1 via respective ones of the electrical conductors 202 and 216 and the optical fibers 204 and 208.

Referring now to FIG. 3, the voice electrical/optical mux/demux 206 includes an analog/PCM converter 302 to convert analog voice signals received via the electrical conductors 202 to electrical pulse code modulated (“PCM”) voice signals. To convert optical TDM voice signals received via the optical fibers 204 to electrical TDM voice signals, the voice electrical/optical mux/demux 206 is provided with a TDM optical/electrical converter 304. The voice electrical/optical mux/demux 206 is provided with a SONET mux/demux 306 to multiplex and demultiplex the electrical PCM voice signals from the analog/PCM converter 302 and the electrical TDM voice signals from the TDM optical/electrical converter 304 to and from electric SONET (i.e., a synchronous transport signal (“STS”)) voice signals. The voice electrical/optical mux/demux 206 is provided with an electrical interface 308 to transmit and receive STS voice signals to and from the voice-data electrical/optical mux/demux 222.

In the illustrated example, the data electrical/optical mux/demux 220 receives analog DSL (e.g., ADSL, VDSL, or any other DSL standard) data signals via the electrical conductors 216 and receives optical VDSL signals via the optical fibers 218 using an optical Gigabit Ethernet (“Gigabit-E”) protocol defined under the Institute of Electrical and Electronics Engineers (“IEEE”) 802.3z Fiber Optic Gigabit Ethernet specification. To convert the analog DSL data signals received via the electrical conductors 216 to electrical pulse code modulated (“PCM”) data signals, the data electrical/optical mux/demux 220 is provided with an analog/PCM converter 310. To convert optical Gigabit-E VDSL data signals received via the optical fibers 218 to electrical Gigabit-E VDSL data signals, the data electrical/optical mux/demux 220 is provided with a Gigabit-E optical/electrical converter 312. The electrical Gigabit-E standard is defined under the IEEE 802.3ab Twisted-Pair Gigabit Ethernet specification.

The data electrical/optical mux/demux 222 is provided with a SCM mux/demux 314 to multiplex and demultiplex the electrical PCM data signals from the analog/PCM converter 310 and the electrical Gigabit-E VDSL data signals from the Gigabit-E optical/electrical converter 312 to and from electrical SCM data signals. The data electrical/optical mux/demux 220 is provided with an electrical interface 316 to transmit and receive the electrical SCM data signals to and from the voice-data electrical/optical mux/demux 222.

To exchange electrical SONET voice signals with the voice electrical/optical mux/demux 206 and electrical SCM data signals with the data electrical/optical mux/demux 220, the voice-data electrical/optical mux/demux 222 is provided with an electrical interface 318. To convert the electrical SONET voice signals received from the voice electrical/optical mux/demux 206 to optical TDM voice signals, the voice-data electrical/optical mux/demux 222 is provided with a SONET/TDM mux/demux 320. The SONET/TDM mux/demux 320 is communicatively coupled to an optical interface 322 to communicate the optical SONET voice signals to the customer sites 104 (FIG. 1) via an optical fiber 324 (e.g., one of the optical fibers 226 of FIG. 2).

To convert the electrical SCM data signals received from the data electrical/optical mux/demux 220 to optical SCM data signals, the voice-data electrical/optical mux/demux 222 is provided with a SCM mux/demux 326. The SCM mux/demux 326 is communicatively coupled to the optical interface 322 to communicate the optical SCM data signals to the customer sites 104 (FIG. 1) via an optical fiber 328 (e.g., one of the optical fibers 226 of FIG. 2). In an alternative example implementation, the data electrical/optical mux/demux 220 may be provided with a quadrature amplitude modulation (“QAM”) mux/demux or a vestigial side band (“VSB”) modulation mux/demux instead of the SCM mux/demux 326 to convert the electrical SCM data signals to optical QAM data signals or optical VSB data signals and communicate data information to subscribers via the optical QAM data signals or the optical VSB data signals.

In the illustrated example, the DWDM interface 230 is provided with a DWDM mux/demux 330 to convert the electrical SONET voice signals from the voice electrical/optical mux/demux 206 and the electrical SCM data signals from the data electrical/optical mux/demux 220 to optical DWDM signals. The DWDM mux/demux 330 can be used instead of or in addition to the SONET/TDM mux/demux 320 and the SCM mux/demux 326 to deliver combined voice information and data information via the same optical fiber. The DWDM mux/demux 330 is communicatively coupled to the optical interface 322 to communicate the DWDM voice-data signals to the customer sites 104 (FIG. 1) via an optical fiber 332 (e.g., one of the optical fibers 226 of FIG. 2).

To deliver power to add-drop multiplexers (“ADM's”) (e.g., the ADM's 144a and 144b of FIG. 1) communicatively coupled to the SAI 140 and/or to any other telecommunications equipment (e.g., customer premises equipment) communicatively coupled to the SAI 140, the SAI 140 is provided with a power interface 334. In the illustrated example, the power interface 334 obtains power from the hybrid cable 208, which may be delivered from, for example, the central office 102 (FIG. 1). Also in the illustrated example, to ensure that voice communications are substantially always available to the customer sites 104 (FIG. 1), the power interface 334 is communicatively coupled to an electrical conductor 336 associated with the optical voice signals. In this manner, electrical power can be delivered to those portions of telecommunications equipment (e.g., the ADM's 144a-b (FIG. 1), the NID's 148 (FIG. 1), etc.) that process voice signals to provide voice communications. Regulations of the Federal Communications Commission (“FCC”) require that voice communications not fail for more than a minimum threshold of time per year. Therefore, if a reliable power source local to the ADM's 144a-b and the NID's 148 of FIG. 1 is not available, the power interface 334 can be used to deliver substantially reliable electrical power to ensure that reliable voice communications are provided in accordance with FCC regulations.

In addition, the power interface 334 may also be electrically coupled to electrical conductors 338 and 340 associated with the optical data signals and the DWDM signals. In an example implementation in which the DWDM protocol is used exclusively to provide voice and data services to one or more of the customer sites 104 (FIG. 1), to ensure reliable voice services, the power interface 334 should be connected to the electrical conductor 340 absent a local source of electrical power to power, for example, the ADM's 144a-b and the NID's 148.

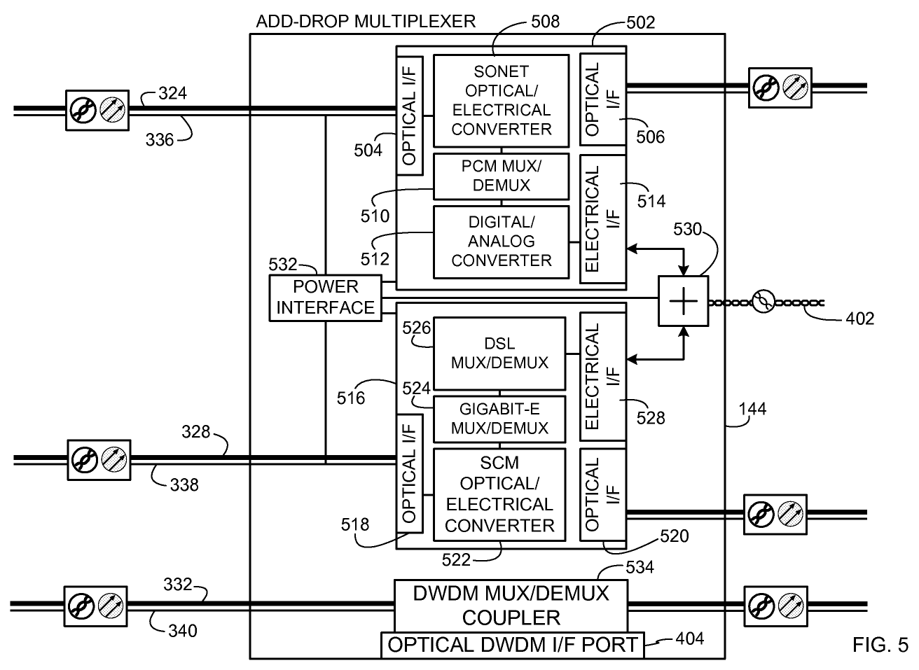

FIG. 4 is a general block diagram and FIG. 5 is a detailed block diagram of the add-drop multiplexer (“ADM”) 144a of the example network system 100 of FIG. 1. The ADM 144a (e.g., a subscriber distribution device) may be installed in or near a residential neighborhood or other service area to provide communication services to subscribers (e.g., the customer sites 104 of FIG. 1) in that service area. Specifically, the ADM 144a receives communication signals transmitted by the SAI 140 (FIGS. 1-3), demultiplexes voice and data information intended for ones of the customer sites 104 connected to the ADM 144a and forwards the demultiplexed voice and/or data information to corresponding ones of the customer sites 104. In addition, the ADM 144a transmits the communication signals received from the SAI 140 to a subsequent ADM such as the ADM 144b of FIG. 1 so that the ADM 144b can demultiplex voice and/or data information from the communication signals intended for ones of the customer sites 104 connected thereto. In this manner, a plurality of ADM's can communicate information between the SAI 140 and the customer sites 104. Although the ADM 144a is described as receiving signals from the SAI 140 and providing voice and/or data information to the customer sites 104, the ADM 144a is also configured to perform a reverse process including receiving voice and/or data information provided by the customer sites 104, multiplexing the voice and/or data information into one or more multiplexed communication signals, and communicating the multiplexed communication signals to the SAI 140.

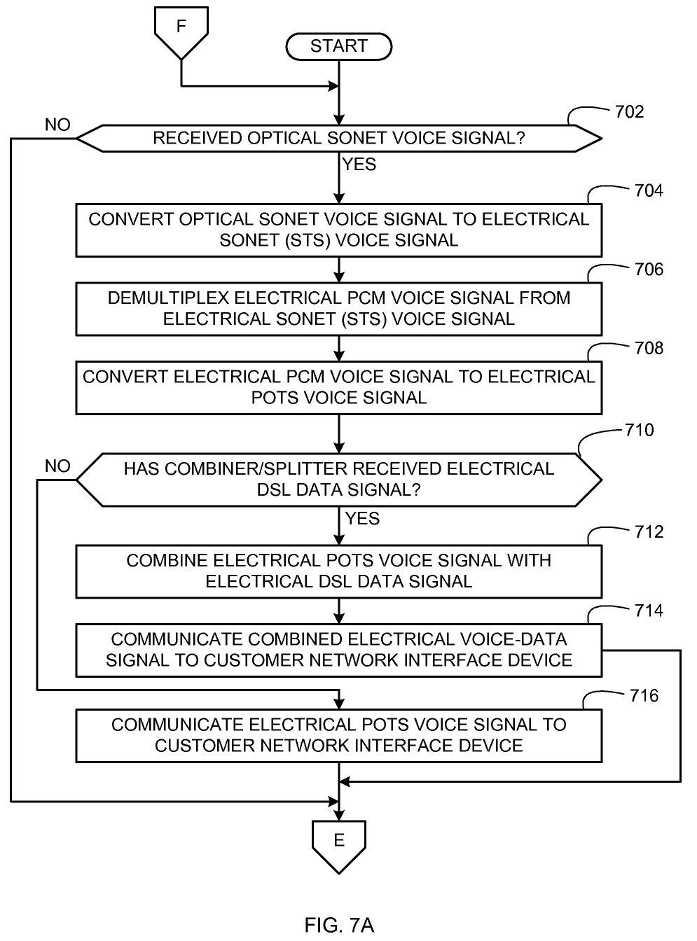

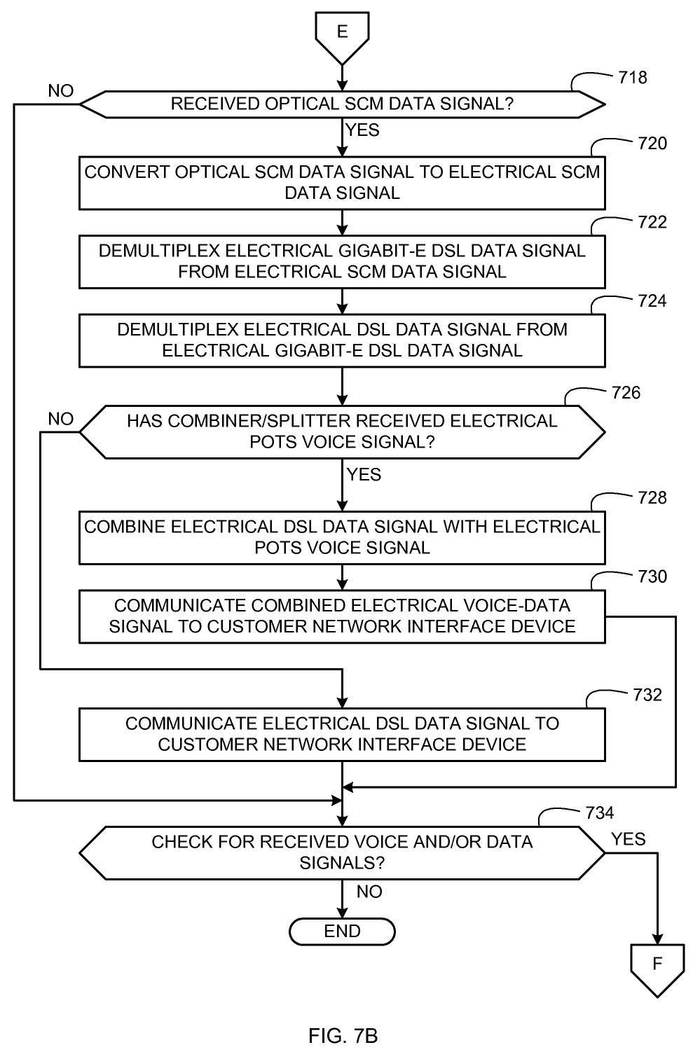

The example structures shown in FIGS. 4 and 5 may be implemented using any desired combination of hardware and/or software. For example, one or more integrated circuits, discrete semiconductor components, or passive electronic components may be used. Additionally or alternatively, some or all, or parts thereof, of the example structures of FIGS. 4 and 5 may be implemented using instructions, code, or other software and/or firmware, etc. stored on a computer-readable medium that, when executed by, for example, a processor system (e.g., the processor system 810 of FIG. 8), perform the methods described herein. Further, the example methods described below in connection with FIGS. 7A and 7B describe example operations or processes that may be used to implement some or all of the functions or operations associated with the structures shown in FIGS. 4 and 5.

Turning to FIG. 4, the hybrid cable 142 from the SAI 140 is communicatively coupled to the ADM 144a. The hybrid cable 142 includes the plurality of optical fibers 324, 328, and 332 and the plurality of electrical conductors 336, 338, and 340 described above in connection with FIG. 3 to communicate voice and/or data signals between the SAI 140 and the ADM 144a. To relay, forward, or otherwise communicate the voice and/or data signals received from the SAI 140 to the ADM 144b, the ADM 144a is communicatively coupled to the hybrid cable 152. As described below in connection with FIG. 5, the hybrid cable 152 includes optical fibers and electrical conductors substantially similar or identical to the optical fibers 324, 328, and 332 (FIG. 3) and the electrical conductors 336, 338, and 340 (FIG. 3) of the hybrid cable 142.

The ADM 144a transmits and receives voice and/or data information to and from the NID's 148 of the customer sites 104 via electrical conductors 402. In the illustrated example, the electrical conductors 402 are twisted-pair copper conductors that obtain electrical power provided by the power interface 334 (FIG. 3) of the SAI 140 and provide the electrical power to the NID's 148 to power the NID's 148 (e.g., customer premises equipment).

To implement a fiber to the home (FTTH) network in which voice and/or data information is communicated between the subscriber sites 104 and the central office 102 via optical fibers without any intervening electrically conductive transmission media segments, the ADM 144a includes a plurality of DWDM optical interface ports 404 to communicatively couple optical fibers between the ADM 144a and customer sites having optical NID's.

Now turning to FIG. 5, to provide voice services to the customer sites 104, the ADM 144a is provided with a voice electrical/optical mux/demux 502 that includes an optical interface 504 communicatively coupled to the optical fiber 324 to receive optical voice signals from the SAI 140. The voice electrical/optical mux/demux 502 includes another optical interface 506 to relay, forward, or otherwise communicate the optical voice signals (e.g., optical SONET/TDM voice signals) received from the SAI 140 to the ADM 144b. To convert optical SONET voice signals to electrical SONET (i.e., STS) voice signals, the voice electrical/optical mux/demux 502 is provided with a SONET optical/electrical converter 508. To multiplex and demultiplex PCM voice information to and from the electrical SONET voice signals for respective customer sites 104 coupled to the ADM 144a, the voice electrical/optical mux/demux 502 is provided with a PCM mux/demux 510. To convert the PCM voice signals to analog TDM POTS voice signals, the voice electrical/optical mux/demux 502 is provided with a digital/analog converter 512. The digital/analog converter 512 communicates the analog TDM POTS voice signals to an electrical interface 514.

To provide data services to the customer sites 104, the ADM 144a is provided with a data electrical/optical mux/demux 516. The data electrical/optical mux/demux 516 includes an optical interface 518 communicatively coupled to the optical fiber 328 to receive optical data signals from the SAI 140. The data electrical/optical mux/demux 516 includes another optical interface 520 to relay, forward, or otherwise communicate the optical data signals (e.g., optical SCM data signals) received from the SAI 140 to the ADM 144b. To convert optical SCM data signals to electrical SCM data signals, the data electrical/optical mux/demux 516 is provided with a SCM optical/electrical converter 522. To multiplex and demultiplex Gigabit-E data to and from the electrical SCM data signals for respective customer sites 104 coupled to the ADM 144a, the data electrical/optical mux/demux 516 is provided with a Gigabit-E mux/demux 524. To multiplex and demultiplex DSL signals (e.g., ADSL or VDSL signals) to and from the Gigabit-E signals, the data electrical/optical mux/demux 516 is provided with a DSL mux/demux 526. The DSL mux/demux 526 communicates the DSL signals to an electrical interface 528.

The electrical interface 514 of the voice electrical/optical mux/demux 502 and the electrical interface 528 of the data electrical/optical mux/demux 516 are communicatively coupled to a combiner/splitter 530. The combiner/splitter 530 combines the TDM POTS voice signals received from the electrical interface 514 and the DSL data signals received from the electrical interface 528 and communicates the combined signals to a respective one of the customer sites 104 (FIGS. 1 and 4) via the electrical conductor 402. The combiner/splitter 530 also receives voice/data signals from the respective customer site 104, splits TDM POTS voice signals from DSL data signals, and transmits the TDM POTS voice signals to the electrical interface 514 and the DSL data signals to the electrical interface 528 to be communicated to the SAI 140 and the central office 102 (FIG. 1). Although not shown, the ADM 144a includes a combiner/splitter for each of the NID's 148 coupled to the ADM 144a.

In the illustrated example, the voice electrical/optical mux/demux 502, the data electrical/optical mux/demux 516, and the combiner/splitter 530 are powered by a power interface 532, which obtains electrical power from the power interface 334 (FIG. 3) of the SAI 140 via electrical conductors 336 and 338. On some example implementations, the power interface 532 may power the voice electrical/optical mux/demux 502 and the combiner/splitter 530 using electrical power received from the SAI 140 to ensure reliable and continuous availability of voice services, and the power interface 532 may power the data electrical/optical mux/demux 516 using power obtained locally from, for example, a power company power grid.

In the illustrated example, each of the DWDM optical interface ports 404 of the ADM 144a is communicatively coupled to a DWDM mux/demux coupler 534 to enable implementing a fiber to the home (“FTTH”) communication path containing optical fiber transmission media from the central office 102 to an optical NID of a customer site. That is, instead of delivering voice and data signals to the NID's 148 using the electrical conductors 402, an FTTH circuit delivers voice and data signals to an optical NID via an optical fiber communicatively coupling the ADM 144a to the optical NID.

The DWDM mux/demux coupler 534 is communicatively coupled to the DWDM interface 230 (FIGS. 2 and 3) of the SAI 140 via the optical fiber 332 (FIGS. 3 and 5) and receives DWDM signals having combined voice and data information. The DWDM mux/demux 534 is configured to demultiplex voice and/or data information corresponding to a respective one of the customer sites 104 connected to the optical DWDM interface port 404 and communicates the voice and/or data information via an optical signal to the customer site 104. The DWDM mux/demux coupler 534 also receives voice and/or data information from the customer site 104, multiplexes the voice and/or data information into a DWDM signal, and communicates the DWDM signal to the SAI 140 for transmission to the central office 102. In addition, the DWDM mux/demux coupler 534 relays, forwards, or otherwise communicates the DWDM signals received from the SAI 140 to a subsequent ADM (e.g., the ADM 144b) connected to the ADM 144a. In the illustrated example, the DWDM mux/demux coupler 534 and the optical DWDM interface port 404 are powered by electrical power received from the power interface 334 (FIG. 3) of the SAI 140.

FIGS. 6A-6D depict flow diagrams of example methods that may be used to implement the example SAI 140 of FIGS. 1-3 and FIGS. 7A and 7B depict flow diagrams of example methods that may be used to implement the example add-drop module 144a of FIGS. 1, 4, and 5. In an example implementation, the flow diagrams of FIGS. 6A-6D, 7A, and 7B are representative of example machine readable and executable instructions. In the example implementation, the machine readable instructions comprise a program for execution by a processor such as the processor 812 shown in the example processor system 810 of FIG. 8. The program may be embodied in software stored on a tangible medium such as a CD-ROM, a floppy disk, a hard drive, a digital versatile disk (“DVD”), or a memory associated with the processor 812 and/or embodied in firmware or dedicated hardware in a well-known manner. For example, the voice electrical/optical mux/demux 206 (FIG. 2), the data electrical/optical mux/demux 220 (FIG. 2), the voice-data electrical/optical mux/demux 222 (FIG. 2), the DWDM interface 230 (FIG. 2), the voice electrical/optical mux/demux 502 (FIG. 5), the data electrical/optical mux/demux 516 (FIG. 5), the DWDM mux/demux coupler 534 (FIG. 5), and/or the optical DWDM interface port 404 (FIGS. 4 and 5) could be implemented using software, hardware, and/or firmware. Further, although the example program is described with reference to the flowcharts illustrated in FIGS. 6A-6D, 7A, and 7B, persons of ordinary skill in the art will readily appreciate that many other methods of implementing the example methods and apparatus described herein may alternatively be used. For example, the order of execution of the blocks may be changed, and/or some of the blocks described may be changed, eliminated, or combined. In addition, although the operations of the flowcharts are described below as occurring in serial fashion, some or all of the operations may alternatively or additionally be performed in parallel such that two or more entities may receive signals, transmit signals, convert signals, multiplex signals, and/or demultiplex signals substantially simultaneously.

Turning to FIG. 6A, initially, the analog/PCM converter 302 (FIG. 3) determines if it has received an electrical POTS voice signal (block 602). For example, the analog/PCM converter 302 may check a receive data bit, a buffer in bit, a signal receive flag, etc. that indicates when an electrical POTS voice signal containing POTS voice information has been received. If the analog/PCM converter 302 determines that an electrical POTS voice signal has been received (block 602), the analog/PCM converter 302 converts the electrical POTS voice signal into an electrical PCM voice signal (block 604). The SONET mux/demux 306 (FIG. 3) then multiplexes the electrical PCM voice signal provided by the analog/PCM converter 302 into an electrical SONET voice signal (i.e., an STS voice signal) (block 606).

After multiplexing the electrical PCM voice signal into an electrical SONET voice signal (block 606) or if the analog/PCM converter 302 determines that it has not yet received an electrical POTS voice signal (block 602), the TDM optical/electrical converter 304 (FIG. 3) determines whether it has received an optical TDM voice signal (block 608). For example, the TDM optical/electrical converter 304 may check a receive data bit, a buffer in bit, a signal receive flag, etc. that indicates when an optical TDM voice signal containing TDM voice information has been received. If the TDM optical/electrical converter 304 determines that an optical TDM voice signal has been received (block 608), the TDM optical/electrical converter 304 converts the optical TDM voice signal into an electrical TDM voice signal (block 610). The SONET mux/demux 306 (FIG. 3) then multiplexes the electrical TDM voice signal provided by the TDM optical/electrical converter 304 into an electrical SONET voice signal (i.e., an STS voice signal) (block 612).

After the SONET mux/demux 306 multiplexes the electrical TDM voice signal into an electrical SONET voice signal (block 612) or if the TDM optical/electrical converter 304 determines that it has not received an optical TDM voice signal (block 608), the analog/PCM converter 310 (FIG. 3) determines whether it has received an electrical DSL (e.g., ADSL or VDSL) data signal (block 614) (FIG. 6B). For example, the analog/PCM converter 310 may check a receive data bit, a buffer in bit, a signal receive flag, etc. that indicates when an electrical DSL data signal containing DSL data information has been received. If the analog/PCM converter 310 determines that an electrical DSL data signal has been received (block 614), the analog/PCM converter 310 converts the electrical DSL data signal into an electrical PCM data signal (block 616) (e.g., a DSL signal encoded using PCM). The SCM mux/demux 314 (FIG. 3) then multiplexes the electrical PCM data signal provided by the analog/PCM converter 310 into an electrical SCM data signal (block 618).

After the SCM mux/demux 314 multiplexes the electrical PCM data signal into an electrical SCM data signal (block 618) or if the analog/PCM converter 310 determines that it has not received an electrical DSL data signal (block 614), the Gigabit-E optical/electrical converter 312 (FIG. 3) determines whether it has received an optical Gigabit-E DSL (e.g., ADSL or VDSL) data signal (block 620). An optical Gigabit-E DSL data signal is a DSL signal transmitted using the optical Gigabit-E communication standard. To determine whether it has received an optical Gigabit-E DSL signal, the Gigabit-E optical/electrical converter 312 may check a receive data bit, a buffer in bit, a signal receive flag, etc. that indicates when an optical Gigabit-E DSL data signal containing DSL data information has been received. If the Gigabit-E optical/electrical converter 312 determines that it has received an optical Gigabit-E DSL data signal (block 620), the Gigabit-E optical/electrical converter 312 converts the optical Gigabit-E DSL data signal into an electrical Gigabit-E DSL data signal (block 622) (e.g., a DSL signal within an electrical Gigabit-E signal). The SCM mux/demux 314 (FIG. 3) then multiplexes the electrical Gigabit-E DSL data signal provided by the Gigabit-E optical/electrical converter 312 into an electrical SCM data signal (block 624).

After the SCM mux/demux 314 multiplexes the electrical DSL PCM data signal into an electrical SCM data signal (block 624) or if the Gigabit-E optical/electrical converter 312 determines that it has not received an electrical Gigabit-E DSL data signal (block 620), the voice-data electrical/optical mux/demux 222 (FIG. 3) determines whether an electrical SONET (i.e., an STS) voice signal is available (block 626) (FIG. 6C). For example, the voice-data electrical/optical mux/demux 222 may check a receive data bit, a buffer in bit, a signal receive flag, etc. that indicates when it has received an electrical SONET voice signal from the voice electrical/optical mux/demux 206 (FIGS. 2 and 3). If the voice-data electrical/optical mux/demux 222 determines that it has received an electrical SONET voice signal (block 626), the voice-data electrical/optical mux/demux 222 determines whether it should communicate the electrical SONET voice signal via optical TDM (block 628) to, for example, the add-drop multiplexer (“ADM”) 144a (FIGS. 1, 4, and 5). For example, the voice-data electrical/optical mux/demux 222 may check a configuration bit that indicates whether it should communicate the electrical SONET voice signal via optical TDM.

If the voice-data electrical/optical mux/demux 222 determines that it should communicate the electrical SONET voice signal via optical TDM (block 628), the SONET/TDM mux/demux 320 converts the electrical SONET voice signal to an optical SONET TDM voice signal (block 630) (e.g., a TDM signal in a SONET signal) and communicates the optical SONET TDM voice signal to an add-drop multiplexer (e.g., the ADM 144a of FIGS. 1, 4, and 5) (block 632) via, for example, the optical fiber 324 (FIG. 3).

After the SONET/TDM mux/demux 320 communicates the optical SONET TDM voice signal to an add-drop multiplexer (block 632) or if the voice-data electrical/optical mux/demux 222 determines that it should not communicate the electrical SONET voice signal via optical TDM (block 628), the voice-data electrical/optical mux/demux 222 determines whether it should communicate the electrical SONET voice signal via optical DWDM (block 634). For example, the voice-data electrical/optical mux/demux 222 may check a configuration bit that indicates whether it should communicate the electrical SONET voice signal via optical DWDM. If the voice-data electrical/optical mux/demux 222 determines that it should communicate the electrical SONET voice signal via optical DWDM (block 634), the DWDM mux/demux 330 (FIG. 3) converts the electrical SONET voice signal to an optical DWDM signal (block 636) and communicates the optical DWDM signal to an add-drop multiplexer (e.g., the ADM 144a) (block 638) via, for example, the optical fiber 332 (FIG. 3).

After the DWDM mux/demux 330 communicates the optical DWDM signal (block 638) or if the voice-data electrical/optical mux/demux 222 determines that it should not communicate the electrical SONET voice signal via optical DWDM (block 634) or if the voice-data electrical/optical mux/demux 222 determines that it has not received an electrical SONET voice signal (block 626), the voice-data electrical/optical mux/demux 222 determines whether an electrical SCM data signal is available (block 640) (FIG. 6D). For example, the voice-data electrical/optical mux/demux 222 may check a receive data bit, a buffer in bit, a signal receive flag, etc. that indicates when it has received an electrical SCM data signal from the data electrical/optical mux/demux 220 (FIGS. 2 and 3). If the voice-data electrical/optical mux/demux 222 determines that it has received an electrical SCM data signal (block 640), the voice-data electrical/optical mux/demux 222 determines whether it should communicate the electrical SCM data signal via optical SCM (block 642) to, for example, the add-drop multiplexer 144a (FIGS. 1, 4, and 5). For example, the voice-data electrical/optical mux/demux 222 may check a configuration bit that indicates whether it should communicate the electrical SCM data signal via optical SCM.

If the voice-data electrical/optical mux/demux 222 determines that it should communicate the electrical SCM data signal via optical SCM (block 642), the SCM mux/demux 326 converts the electrical SCM data signal to an optical SCM data signal (block 644) and communicates the optical SCM data signal to an add-drop multiplexer (e.g., the ADM 144a of FIGS. 1, 4, and 5) (block 646) via, for example, the optical fiber 328 (FIG. 3).

After the SCM mux/demux 326 communicates the optical SCM data signal to an add-drop multiplexer (block 646) or if the voice-data electrical/optical mux/demux 222 determines that it should not communicate the electrical SCM data signal via optical SCM (block 640), the voice-data electrical/optical mux/demux 222 determines whether it should communicate the electrical SCM data signal via optical DWDM (block 648). For example, the voice-data electrical/optical mux/demux 222 may check a configuration bit that indicates whether it should communicate the electrical SCM data signal via optical DWDM. If the voice-data electrical/optical mux/demux 222 determines that it should communicate the electrical SCM data signal via optical DWDM (block 648), the DWDM mux/demux 330 (FIG. 3) converts the electrical SCM data signal to optical an optical DWDM signal (block 650) and communicates the optical DWDM signal to an add-drop multiplexer (e.g., the ADM 144a) (block 652) via, for example, the optical fiber 332 (FIG. 3). As described above, the DWDM signal is a data-voice signal that can be used to transmit voice and data via the same optical fiber (e.g., the optical fiber 332). Therefore, at block 652, the optical DWDM signal may be used to substantially simultaneously communicate the DSL data information from the electrical SCM data signal and voice information from an electrical SONET voice signal.

After the voice-data electrical/optical mux/demux 222 communicates the optical DWDM signal to an add-drop multiplexer (block 652) or if the voice-data electrical/optical mux/demux 222 determines that it should communicate the electrical SCM data signal via optical DWDM (block 648) or if the voice-data electrical/optical mux/demux 222 determines that it should not communicate the electrical SCM data signal via optical SCM (block 640), the SAI 140 determines whether it should check for received voice and/or data signals (block 654) (e.g., voice and/or data signals received by the voice electrical/optical mux/demux 206 or the data electrical/optical mux/demux 220 of FIGS. 2 and 3). If the SAI 140 determines that it should check for received voice and/or data signals (block 654), then control returns to block 602 (FIG. 6A). Otherwise, the example process of FIGS. 6A-6D is ended.

As mentioned above, the flowcharts of FIGS. 7A and 7B depict an example method of implementing the ADM 144a of FIGS. 1, 4, and 5. Now turning in detail to FIG. 7A, the SONET optical/electrical converter 508 (FIG. 5) determines whether it has received an optical SONET voice signal (block 702). For example, the SONET optical/electrical converter 508 may check a receive data bit, a buffer in bit, a signal receive flag, etc. that indicates when the SONET optical/electrical converter 508 has received an optical SONET voice signal. If the SONET optical/electrical converter 508 determines that it has received an optical SONET voice signal (block 702), the SONET optical/electrical converter 508 converts the optical SONET voice signal to an electrical SONET voice signal (i.e., an STS voice signal) (block 704). The PCM mux/demux 510 (FIG. 5) then demultiplexes an electrical PCM voice signal from the electrical SONET voice signal (block 706). The digital/analog converter (block 512) then converts the electrical PCM voice signal to an electrical POTS voice signal (block 708).

The combiner/splitter 530 (FIG. 5) then determines whether it has received an electrical DSL data signal (block 710) from, for example, the data electrical/optical mux/demux 516 (FIG. 5). For example, the combiner/splitter 530 may check a receive data bit, a buffer in bit, a signal receive flag, etc. that indicates when the combiner/splitter 530 has received an electrical DSL data signal. If the combiner/splitter 530 determines that it has received an electrical DSL data signal (block 710), the combiner/splitter 530 combines the electrical POTS voice signal (e.g., the electrical POTS voice signal provided by the digital/analog converter 512 at block 708) with the electrical DSL data signal (block 712). The combiner/splitter 530 then communicates the combined electrical voice-data signal to a respective customer network interface device (“NID”) (block 714) such as, for example, one of the NID's 148 of FIGS. 1 and 4. Otherwise, if the combiner/splitter 530 determines that it has not received the electrical DSL data signal (block 710), the combiner/splitter 530 communicates the electrical POTS voice signal (e.g., the electrical POTS voice signal provided by the digital/analog converter 512 at block 708) to a customer NID (block 716) such as, for example, a respective one of the customer NID's 148.

After the combiner/splitter 530 communicates the electrical POTS voice signal (block 716) or after the combiner/splitter 530 communicates the combined electrical voice-data signal (block 714) or if the SONET optical/electrical converter 508 (FIG. 5) determines it did not receive an optical SONET voice signal (block 702), the SCM optical/electrical converter 522 (FIG. 5) determines whether it has received an optical SCM data signal (block 718) (FIG. 7B). If the SCM optical/electrical converter 522 determines that it has received an optical SCM data signal (block 718), the SCM optical/electrical converter 522 converts the optical SCM data signal to an electrical SCM data signal (block 720). The Gigabit-E mux/demux 524 (FIG. 5) then demultiplexes an electrical Gigabit-E DSL data signal from the electrical SCM data signal (block 722). The DSL mux/demux 526 (FIG. 5) then demultiplexes an electrical DSL data signal from the electrical Gigabit-E DSL data signal (block 724).

The combiner/splitter 530 (FIG. 5) then determines whether it has received an electrical POTS voice signal (block 726) from, for example, the voice electrical/optical mux/demux 502 (FIG. 5). For example, the combiner/splitter 530 may check a receive data bit, a buffer in bit, a signal receive flag, etc. that indicates when the combiner/splitter 530 has received an electrical POTS voice signal. If the combiner/splitter 530 determines that it has received an electrical POTS voice signal (block 726), the combiner/splitter 530 combines the electrical DSL data signal (e.g., the electrical DSL data signal provided by the DSL mux/demux 526 at block 724) with the electrical POTS voice signal (block 728). The combiner/splitter 530 then communicates the combined electrical voice-data signal to a respective customer network interface device (“NID”) (block 730) such as, for example, one of the NID's 148 of FIGS. 1 and 4. Otherwise, if the combiner/splitter 530 determines that it has not received the electrical POTS voice signal (block 726), the combiner/splitter 530 communicates the electrical DSL data signal (e.g., the electrical DSL data signal provided by the DSL mux/demux 526 at block 724) to a customer NID (block 732) such as, for example, a respective one of the customer NID's 148.

After the combiner/splitter 530 communicates the electrical DSL data signal (block 732) or after the combiner/splitter 530 communicates the combined electrical voice-data signal (block 730) or if the SCM optical/electrical converter 522 (FIG. 5) determines it did not receive an optical SCM data signal (block 718), the ADM 144a determines whether it should check for other received voice and/or data signals (block 734) (e.g., voice and/or data signals received by the voice electrical/optical mux/demux 502 or the data electrical/optical mux/demux 516 of FIG. 5). If the ADM 144a determines that it should check for received voice and/or data signals (block 734), then control returns to block 702 (FIG. 7A). Otherwise, the example process of FIGS. 7A and 7B is ended.

FIG. 8 is a block diagram of an example processor system 810 that may be used to implement the example apparatus, methods, and articles of manufacture described herein. As shown in FIG. 8, the processor system 810 includes a processor 812 that is coupled to an interconnection bus 814. The processor 812 includes a register set or register space 816, which is depicted in FIG. 8 as being entirely on-chip, but which could alternatively be located entirely or partially off-chip and directly coupled to the processor 812 via dedicated electrical connections and/or via the interconnection bus 814. The processor 812 may be any suitable processor, processing unit or microprocessor. Although not shown in FIG. 8, the system 810 may be a multi-processor system and, thus, may include one or more additional processors that are identical or similar to the processor 812 and that are communicatively coupled to the interconnection bus 814.

The processor 812 of FIG. 8 is coupled to a chipset 818, which includes a memory controller 820 and an input/output (I/O) controller 822. A chipset provides I/O and memory management functions as well as a plurality of general purpose and/or special purpose registers, timers, etc. that are accessible or used by one or more processors coupled to the chipset 818. The memory controller 820 performs functions that enable the processor 812 (or processors if there are multiple processors) to access a system memory 824 and a mass storage memory 825.

The system memory 824 may include any desired type of volatile and/or non-volatile memory such as, for example, static random access memory (SRAM), dynamic random access memory (DRAM), flash memory, read-only memory (ROM), etc. The mass storage memory 825 may include any desired type of mass storage device including hard disk drives, optical drives, tape storage devices, etc.

The I/O controller 822 performs functions that enable the processor 812 to communicate with peripheral input/output (I/O) devices 826 and 828 and a network interface 830 via an I/O bus 832. The I/O devices 826 and 828 may be any desired type of I/O device such as, for example, a keyboard, a video display or monitor, a mouse, etc. The network interface 830 may be, for example, an Ethernet device, an asynchronous transfer mode (ATM) device, an 802.11 device, a digital subscriber line (DSL) modem, a cable modem, a cellular modem, etc. that enables the processor system 810 to communicate with another processor system.

While the memory controller 820 and the I/O controller 822 are depicted in FIG. 8 as separate functional blocks within the chipset 818, the functions performed by these blocks may be integrated within a single semiconductor circuit or may be implemented using two or more separate integrated circuits.

Of course, persons of ordinary skill in the art will recognize that the order, size, and proportions of the memory illustrated in the example systems may vary. Additionally, although this patent discloses example systems including, among other components, software or firmware executed on hardware, it will be noted that such systems are merely illustrative and should not be considered as limiting. For example, it is contemplated that any or all of these hardware and software components could be embodied exclusively in hardware, exclusively in software, exclusively in firmware or in some combination of hardware, firmware and/or software. Accordingly, persons of ordinary skill in the art will readily appreciate that the above-described examples are not the only way to implement such systems.

At least some of the above described example methods and/or apparatus are implemented by one or more software and/or firmware programs running on a computer processor. However, dedicated hardware implementations including, but not limited to, an ASIC, programmable logic arrays and other hardware devices can likewise be constructed to implement some or all of the example methods and/or apparatus described herein, either in whole or in part. Furthermore, alternative software implementations including, but not limited to, distributed processing or component/object distributed processing, parallel processing, or virtual machine processing can also be constructed to implement the example methods and/or apparatus described herein.

It should also be noted that the example software and/or firmware implementations described herein are optionally stored on a tangible storage medium, such as: a magnetic medium (e.g., a disk or tape); a magneto-optical or optical medium such as a disk; or a solid state medium such as a memory card or other package that houses one or more read-only (non-volatile) memories, random access memories, or other re-writable (volatile) memories; or a signal containing computer instructions. A digital file attachment to e-mail or other self-contained information archive or set of archives is considered a distribution medium equivalent to a tangible storage medium. Accordingly, the example software and/or firmware described herein can be stored on a tangible storage medium or distribution medium such as those described above or equivalents and successor media.

To the extent the above specification describes example components and functions with reference to particular devices, standards and/or protocols, it is understood that the teachings of the invention are not limited to such devices, standards and/or protocols. Such devices are periodically superseded by faster or more efficient systems having the same general purpose. Accordingly, replacement devices, standards and/or protocols having the same general functions are equivalents which are intended to be included within the scope of the accompanying claims.

Although certain methods, apparatus, systems, and articles of manufacture have been described herein, the scope of coverage of this patent is not limited thereto. To the contrary, this patent covers all methods, apparatus, systems, and articles of manufacture fairly falling within the scope of the appended claims either literally or under the doctrine of equivalents.

What is claimed is:

1. A method comprising:
receiving first communication information via a conductive communication medium and second communication information via a first optical fiber communication medium;
multiplexing the first communication information and the second communication information to form a multiplexed communication signal; and
communicating the multiplexed communication signal via a second optical fiber communication medium to a subscriber distribution device.

2. A method as defined in claim 1, wherein receiving first communication information comprises receiving the first communication information via a plain old telephone system (“POTS”) protocol.

3. A method as defined in claim 2, further comprising converting the first communication information from the plain old telephone system protocol to a time division multiplex (“TDM”) protocol.

4. A method as defined in claim 3, wherein the time division multiplex protocol is associated with a synchronous optical network (“SONET”) protocol.

5. A method as defined in claim 1, wherein the first communication information comprises voice information and is received using a time division multiplex protocol, and wherein the second communication information comprises data information and is received using a digital subscriber line (“DSL”) protocol.

6. A method as defined in claim 1, wherein communicating the multiplexed communication signal via the second optical fiber communication medium comprises communicating the multiplexed communication signal via a dense wavelength division multiplexing (“DWDM”) interface.

7. A method as defined in claim 1, wherein receiving first communication information comprises receiving first communication medium via a serving area interface (“SAI”) terminal.

8. A method as defined in claim 1, wherein the conductive communication medium is a copper communication medium.

9. A method as defined in claim 1, further comprising encoding the second communication information in a sub-carrier multiplex (“SCM”) signal prior to multiplexing the first communication information and the second communication information.

10. A method as defined in claim 1, wherein communicating the multiplexed communication signal via the second optical fiber communication medium comprises communicating the multiplexed communication signal via a hybrid communication medium including the second optical fiber communication medium and a second conductive communication medium.

11. A method as defined in claim 10, further comprising communicating at least one of electrical power, alarm information, or emergency analog communication channels via the second conductive communication medium.

12. A method as defined in claim 1, wherein the multiplexed communication signal includes a very high bit-rate digital subscriber line (“VDSL”) signal within a synchronous optical network signal.

13. A method as defined in claim 1, wherein the multiplexed communication signal includes a digital subscriber line signal within a sub-carrier multiplex signal.

14. An apparatus comprising:
an electrical interface to receive an electrical synchronous optical network (“SONET”) signal and an electrical sub-carrier multiplex (“SCM”) signal carrying a digital subscriber line (“DSL”) signal;
a first multiplexer/demultiplexer communicatively coupled to the electrical interface and configured to convert the electrical synchronous optical network signal to an optical time division multiplex (“TDM”) signal;
a second multiplexer/demultiplexer communicatively coupled to the electrical interface configured to convert the electrical sub-carrier multiplex signal to an optical sub-carrier multiplex (“SCM”) signal; and
an optical interface communicatively coupled to the first multiplexer/demultiplexer and the second multiplexer/demultiplexer and configured to communicate the optical time division multiplex signal via a first optical fiber and the optical sub-carrier multiplex signal via a second optical fiber.

15. An apparatus as defined in claim 14, further comprising a third multiplexer/demultiplexer communicatively coupled to the electrical interface and the optical interface and configured to convert the electrical synchronous optical network signal and the electrical sub-carrier multiplex signal to a dense wavelength division multiplexing (“DWDM”) signal.

16. An apparatus as defined in claim 15, wherein the optical interface is configured to communicate the dense wavelength division multiplexing signal via at least one of the first optical fiber, the second optical fiber, or a third optical fiber.

17. An apparatus as defined in claim 14, wherein the digital subscriber line signal is an asymmetric digital subscriber signal (“ADSL”).

18. An apparatus as defined in claim 14, wherein the electrical synchronous optical network signal includes a pulse code modulated (“PCM”) voice signal.

19. An apparatus as defined in claim 14, wherein the optical interface is configured to communicate the optical time division multiplex signal via a first hybrid cable having the first optical fiber and a first electrical conductor, and wherein the optical interface is configured to communicate the optical sub-carrier multiplex signal via a second hybrid cable having the second optical fiber and a second electrical conductor.

20. An apparatus as defined in claim 14, further comprising an electrical power interface configured to transmit electrical power not having a communication signal via an electrical conductor.

21. An apparatus as defined in claim 20, wherein the electrical power interface is configured to transmit the electrical power via a hybrid cable having the electrical conductor and at least one of the first optical fiber or the second optical fiber.

22. A method comprising:
receiving a multiplexed communication signal via a first optical fiber communication medium, wherein the multiplexed communication signal includes first and second communication information;
demultiplexing the first and second communication information from the first multiplexed communication signal;
communicating the first and second communication information to a subscriber terminal via a conductive communication medium; and
transmitting the multiplexed communication signal via a second optical fiber communication medium.

23. A method as defined in claim 22, wherein the first communication information includes voice information and the second communication information includes data information.

24. A method as defined in claim 22, wherein receiving the multiplexed communication signal comprises receiving the multiplexed communication signal via an add-drop multiplexer.

25. A method as defined in claim 22, wherein the conductive communication medium is a twisted-pair copper communication medium.

26. A method as defined in claim 22, wherein the subscriber terminal is a digital subscriber line terminal unit-remote (“ATU-R”).

27. A method as defined in claim 22, wherein the multiplexed communication signal includes a pulse code modulated (“PCM”) voice signal within a synchronous optical network (“SONET”) signal.

28. A method as defined in claim 22, wherein the multiplexed communication signal includes a digital subscriber line (“DSL”) signal within an optical sub-carrier multiplex (“SCM”) signal.

29. A method as defined in claim 22, wherein communicating the first communication information to the subscriber terminal comprises communicating the first communication information using at least one of a plain old telephone system (“POTS”) protocol or a time division multiplex (“TDM”) protocol.

30. A method as defined in claim 22, wherein communicating the second communication information to the subscriber terminal comprises communicating the second communication information using a digital subscriber line protocol.

31. A method as defined in claim 22, wherein receiving the multiplexed communication signal via the first optical fiber communication medium comprises receiving the multiplexed communication signal using a dense wavelength division multiplexing (“DWDM”) protocol.

32. An apparatus comprising:
a first converter to receive an optical synchronous optical network (“SONET”) signal and convert the optical synchronous optical network signal to a first electrical signal;
a second converter to receive an optical sub-carrier multiplex (“SCM”) protocol signal and convert the optical sub-carrier multiplex protocol signal to a second electrical signal; and
a combiner/splitter to combine the first electrical signal and the second electrical signal to a third electrical signal and communicate the third electrical signal to a customer premises terminal.

33. An apparatus as defined in claim 32, further comprising an electrical power interface configured to receive power via a cable having an electrical conductor and an optical fiber, wherein the power interface is configured to power the first and second converters.

34. An apparatus as defined in claim 32, further comprising a first multiplexer/demultiplexer communicatively coupled to the first converter and configured to extract voice information from the first electrical signal.

35. An apparatus as defined in claim 32, further comprising a first multiplexer/demultiplexer communicatively coupled to the second converter and configured to extract data information from the second electrical signal.

36. An apparatus as defined in claim 32, further comprising an optical interface to transmit at least one of the optical synchronous optical network signal or the optical sub-carrier multiplex protocol signal to a subscriber distribution device.

37. An apparatus as defined in claim 32, wherein the first electrical signal includes a pulse code modulated (“PCM”) signal.

38. An apparatus as defined in claim 32, wherein the optical sub-carrier multiplex protocol signal includes data information encoded using a very high bit-rate digital subscriber line (“VDSL”) protocol.
